(19) United States
(12) Patent Application Publication
(10) Pub. No.: US 2014/0223963 A1
(43) Pub. Date: Aug. 14, 2014

(54) GLASS -CERAMIC MATERIAL AND ITS PRODUCTION METHOD

(71) Applicant: Tamer Pinarci, Istanbul (TR)

(72) Inventor: Emrah Dolekcekic, Eskisehir (TR)

(73) Assignee: Tamer Pinarci, Istanbul (TR)

(21) Appl. No.: 14/346,966

(22) PCT Filed: Aug. 27, 2012
(86) PCT No.: PCT/IB2012/054383

§ 371 Date: Mar. 25, 2014

(30) Foreign Application Priority Data
Oct. 3, 2011 (TR) 2011/09768

(51) Int. Cl. C03B 32/02; C03B 19/02

(52) U.S. Cl. CPC C03B 32/02; C03B 19/02; C03B 2201/00
USPC 65/33.8; 65/100

(57) ABSTRACT

This invention relates to a glass-ceramic material and its production method wherein glass ceramics having low expansion coefficient are produced ecologically and whereby said method comprises the steps of raw material batch preparation (101), melting (102), batch compensation to final composition (103), refining of the gas bubbles (104), shaping process (105) and ceramization (106). Preferably, the glass-ceramic comprises in wt %: 60-70 SiO₂, 15-25 AI₂O₃, 0.5-5 B₂O₃, 3-8 Li₂O, 0.5-2 Na₂O, 0.1-0.8 K₂O, 0.1-1.5 BaO, 0-0.5 CaO, 1-2.5 ZnO, 1-4 TiO₂, 1-4 ZrO₂, 0.1-2.5 P₂O₅, 0-0.5 MgO. The batch compensation step (103) consists in adding 0.5-5 wt % B₂O₃ and 0.1-2.5 wt % P₂O₅ during the melting process (102). Instead of oxide raw materials, carbonates (e.g. Li₂CO₃), nitrates (e.g. KNO₃), or sulphates are used.

### TECHNICAL AREA

This invention is related with a glass-ceramic material and production method thereof wherein glass ceramics with low expansion coefficient are produced ecologically.

### PRIOR ART

Glass-ceramics can be obtained by controlled crystallisation of special designed glasses. These glass-ceramics are highly crytallised materials which have higher mechanical strength, impact resistance and resistance to high temperatures and lower thermal expansion coefficient compared with their glass equivalents. They can be widely used for electrical insulation, kitchenware, dental applications, implants and space research.

Nowadays, lithium-alumina-silicate (LAS) glass ceramics are highly popular due to having high transparency and thermal shock resistance. LAS glass-ceramics have two important crystalline phases, β-quartz solid solution (Li₂O-Al₂O₃-2SiO₂) and β-spodumen (Li₂O-Al₂O₃-4SiO₂). Having one of these phases in the glass-ceramic material could increase the chemical resistance and decrease the thermal expansion coefficient. These glass-ceramics exhibit also high thermal shock resistance and transparency. For that reason, they can find wide number of applications in industry. However, during the processing of these glass- ceramics, especially in the melting section, some of the oxides used (As₂O₃, Sb₂O₃ and PbO etc.) evaporate easily and pollute the environment. For that reason, it is a necessary to find alternative eco-friendly methods and oxides to these harmful ingredients.

In one of the known techniques to produce these glass-ceramics which have low thermal expansion coefficient and high transparency and convenient to use in optical area was documented in US patent number of U.S. Pat. No. 5,336,643. In this glass-ceramic composition, the amount of the main ingredients similar to Al₂O₃, SiO₂ and P₂O₅ were decreased and some amounts of MgO, BaO and ZnO were added. Additionally, as an alternative oxide of P₂O₅ and nucleating agent of TiO₂ and ZrO₂ were also used in this composition.

In another technical document of U.S. Pat. No. 6,060,412 US patent, there is a crystallised glass-ceramic material which was shaped by tension method. Crystal size in this glass-ceramic material was less than 5 μm. Amount of crystals in this material is between 10-85% and changing with controlled crystallisation. Additionally, softening temperature of this material is below its melting temperature.

In another application of transparent product of glass-ceramic material was mentioned in Russian patent of RU2170715. According to this invention, glass-ceramic products were produced with an ecological technique which is environmentally friendly. Additionally, products can be used in ceramic and aviation industry.

### SUMMARY OF THE INVENTION

The aim of this invention is to provide an ecological glass-ceramic material and production method thereof which does not pollute nature and in which alternative oxides are used instead of harmful oxides.

Another aim of this invention is to provide a glass-ceramic material wherein resistance of the product is enhanced and which has high thermal shock resistance, and production method thereof.

### DETAILED EXPLANATION OF THE INVENTION

To achieve the aim of this invention, “a glass-ceramic material and its production method” is illustrated in the attached figure;

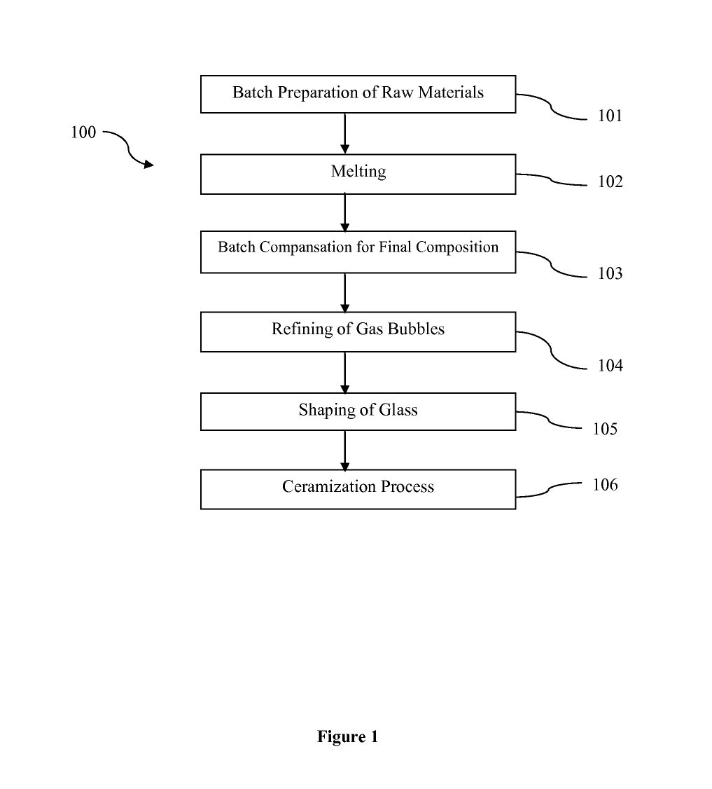

FIG. 1. Flow chart of the production method of the glass-ceramic material of the invention.

“A glass-ceramic material production method” (100) developed to achieve the aim of the invention is comprised of the following steps;
batch preparation of raw material composition (101),
melting (102),
batch compensation for final composition (103),
removal of gas bubbles (refining) (104),
shaping process (105),
ceramization (106).

In the content of the final product produced with the glass-ceramic material production method (100) of the present invention, there are high quartz solid solution phase(s) which enable the glass-ceramic to have high strength and thermal shock resistance. The amount of the said phases should not be less than 70%. To produce a glass-ceramic material having these properties, first of all, raw material batch preparation has to be done (101). This composition is prepared by a plurality of oxides comprising of SiO₂, Al₂O₃, Li₂O, Na₂O, K₂O, BaO, CaO, ZnO, TiO₂, ZrO₂, MgO. However at this point, instead of using pure oxides, carbonates (as in Li₂CO₃), nitrates (as in K₂NO₃) or sulphides (as in BaS) of each one of them are used. Usage of these components facilitates melting process since it decreases the melting temperature in the following stages. None of these oxides or raw materials in carbonate, nitrate and sulphide forms pose any ecological hazard.

Total batch composition is subjected to melting process (102) in special glass melting furnaces which are resistant to high temperatures and alkali containing solutions and are produced by high quality refractory materials containing silicon and zirconium. Temperature inside the furnace, in this step, varies between 1550 and 1700° C. depending on the composition of glass.

Along with the melting (102) procedure, 0.5-5% B₂O₃ and 0.1-2.5% P₂O₅ by weight are added to the batch composition to compensate and obtain the final composition (103). At the end of this step, the final composition will contain: 60-70% SiO₂, 15-25% Al₂O₃, 0.5-5% B₂O₃, 3-8% Li₂O, 0.5-2% Na₂O, 0.1-0.8% K₂O, 0.1-1.5% BaO, 0-0.5% CaO, 1-2.5% ZnO, 1-4% TiO2, 1-4% ZrO₂, 0.1-2.5% P₂O₅ and 0-0.5% MgO by weight.

B₂O₃, which is added at the step of batch compensation to final composition (103), decreases the viscosity of the mixture and enables to remove the gas bubbles (refining) (104) that are formed during melting as a result of decomposition of carbonates, sulphides and nitrates added to the raw materials. The gas bubbles of bigger size move fast within the solution, reach the surface and leave the solution from there. However, since the smaller gas bubbles move much slower in viscous melt, they may get trapped in the final product if not intervened. Presence of these gas bubbles is undesirable since they decrease the strength of the final product. Addition of B₂O₃ also causes ceramization temperature of the mixture to decrease to 500-700° C. Ceramization (106) performed at low temperatures is undesirable as it causes the properties of the final product to change in time during usage of it. Usually, service temperature of glass-ceramic products for stove tops is between 400-600° C. During the step of compensation for the final composition (103), addition of P₂O₅ increases the decreasing ceramization temperature.

In the step of refining (removal of gas bubbles) (104), use of P₂O₅ and B₂O₃ together enables both to remove gas bubbles and to adjust the temperature suitable for the ceramization process (106).

The glass paste molten under high temperatures is then subjected to shaping process (105). Shaping process (105) can be performed with very different methods such as blowing, casting- roller, drawing and floating.

The glass that is shaped is subjected to ceramization (106) in the next stage. The purpose of this process is to form a fine grained structure and accordingly to improve strength and wear resistance of the final product. Ceramization process (106) takes place between 800-950° C. over a period of 5-24 hours.

SiO₂, which is used in the scope of the invention, enables to obtain glass-ceramic phases and increases the strength of final product.

Al₂O₃ in the composition provides the properties of low thermal expansion and transparency to the glass. Additionally, it is a component within the high silica content β-quartz solid solution phases and increases the strength of glass.

Li₂O is a part of structure of β-quartz solid solution. Also, it facilitates melting during melting (102) of the glass ceramic and thereby forms a low viscosity liquid. This in turn increases the homogeneity of the melt.

Na₂O, K₂O, CaO and BaO are added to improve the melting behaviour of glasses. However, these additives increase the residual glass phase amount in the final product of glass-ceramics. For that reason, their amount has to be limited.

B₂O₃ is used to remove the gas bubbles that are formed in the glass-ceramic during the melting process. B₂O₃ decreases the viscosity of melt which increases the speed of the gas bubbles to the surface. This way, since the glass will contain much less imperfections when it becomes final product, it will have a higher strength.

TiO₂ and ZrO₂ are used together as a mixture to enable rapid nucleation and to increase efficiency in the process. Nucleation and transparency depends on TiO₂/ZrO₂ ratio.

Control of nuclei formation and grain growth which constitute two important steps of the ceramization (106) can be determined by high temperature X-ray diffraction equipment within short time and in an efficient way.

Results obtained with this equipment have shown that B₂O₃ coming from the borax raw material (Na₂B₄O₇.10H₂O) used in the invention decreases the ceramization (106) temperature to lower degrees. However, as a known fact, ceramization (106) temperature below 800° C. is not preferred. For that reason, P₂O₅ is added to the mixture to increase the optimum crystallization temperatures above the said value. As a known fact, presence of P₂O₅ increases the amount of crystal formation and increases the crystal formation temperatures to high degrees.

Under the light of these basic concepts, it is possible to develop various embodiments of the inventive glass-ceramic material and its production method (100). The invention can not be limited with these given examples and it is essentially as defined in the claims.

1. A glass-ceramic material production method (100) comprising the steps of
batch preparation of raw material composition (101),
melting (102),
batch compensation for final composition (103),
removal of gas bubbles (refining) (104),
shaping process (105),
ceramization (106);
characterized by the steps of
raw material preparation (101) wherein a plurality of oxides comprising of SiO₂, Al₂O₃, Li₂O, Na₂O, K₂O, BaO, CaO, ZnO, TiO₂, ZrO₂ and MgO are used
batch compensation for final composition (103) wherein, during the melting (102) process, 0.5-5% B₂O₃ and 0.1-2.5% P₂O₅ by weight are added to the said raw material composition,
removal of the gas bubbles (104) wherein both the bubbles are removed and the temperature suitable for ceramization (106) process is adjusted by joint use of P₂O₅ and B₂O₃ compounds.

2. A glass-ceramic material production method (100) according to claim 1, characterized by the step of batch preparation of raw material composition (101) wherein instead of using pure oxides, carbonates (as in Li₂CO₃), nitrides (as in K₂(NO₃)₂) or sulphates (as in BaS) of each one of them are used to decrease the melting point of the composition and facilitate melting process (102).

3. A glass-ceramic material production method (100) according to any of the preceding claims, characterized by the step of melting (102) wherein the raw material composition is processed within special glass furnaces of 1550-1700° C. which are resistant to high temperatures and alkali containing solutions, and are produced by high quality refractory materials containing silicon and zirconium.

4. A glass-ceramic material production method (100) according to any of the preceding claims, characterized by the step of batch compensation for final composition (103) wherein the oxides of SiO₂, Al₂O₃, B₂O₃, Li₂O, Na₂O, K₂O, BaO, CaO, ZnO, TiO₂, ZrO₂, P₂O₅ and MgO are present in the composition at a weight ratio of 60-70%, 15-25%, 0.5-5%, 3-8%, 0.5-2%, 0.1-0.8%, 0.1-1.5%, 0-0.5%, 1-2.5%, 1-4%, 1-4%, 0.1-2.5% and 0-0.5% by weight, respectively.

5. A glass-ceramic material production method (100) according to any of the preceding claims, characterized by the step of ceramization (106) which is performed at 800-950° C. over a period of 5-24 hours and which improves strength and wear resistance of the final product.

6. A glass-ceramic material production method (100) according to any of the preceding claims, characterized by the step of shaping process (105) wherein different methods such as blowing, casting- roller, drawing and floating can be performed.

7. A glass-ceramic material production method (100) according to any of the preceding claims, characterized by the step of batch preparation of raw material composition (101) wherein SiO₂ enables to obtain glass-ceramic phases and increases the strength of final glass-ceramic product.

8. A glass-ceramic material production method (100) according to any of the preceding claims, characterized by the step of batch preparation of raw material composition (101) wherein Al₂O₃ provides the properties of low thermal expansion and transparency and high strength to the final glass-ceramic product.

9. A glass-ceramic material production method (100) according to any of the preceding claims, characterized by the step of batch preparation of raw material composition (101) wherein Li₂O facilitates melting of the glass ceramic and increases the homogeneity during melting step (102) and thereby forms a low viscosity liquid.

10. A glass-ceramic material production method (100) according to any of the preceding claims, characterized by the step of batch preparation of raw material composition (101) wherein Na₂O, K₂O, CaO and BaO improve the melting behaviour of glass-ceramic.

11. A glass-ceramic material production method (100) according to any of the preceding claims, characterized by the step of batch preparation of raw material composition (101) wherein B₂O₃ decreases the viscosity of melt which increases the speed of the gas bubbles to the surface and provides high strength to the final glass-ceramic product since the glass will contain much less imperfections.

12. A glass-ceramic material production method (100) according to any of the preceding claims, characterized by the step of batch preparation of raw material composition (101) wherein TiO₂ and ZrO₂ are present together to enable rapid nucleation and to increase efficiency in the process.

13. A glass-ceramic material production method (100) according to any of the preceding claims, characterized by the step of batch preparation of raw material composition (101) wherein P₂O₅ is added to the mixture to increase the crystallization temperature above 800° C. since ceramization (106) temperature below the said value is not preferred.

14. A glass-ceramic material which is obtained by a method as in any of the claims above.
